(19) United States
(12) Patent Application Publication
(10) Pub. No.: US 2007/0042805 A1
(43) Pub. Date: Feb. 22, 2007

(54) Communications device comprising a touch-sensitive display unit and an actuating element for selecting highlighted characters

(76) Inventor: Alexander Jarczyk, Freising (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/576,426

(22) PCT Filed: Oct. 20, 2004
(86) PCT No.: PCT/EP04/52597

§ 371 Date: Apr. 20, 2006

(30) Foreign Application Priority Data
Oct. 21, 2003 (DE) 103 48 873.1

(51) Int. Cl. H04M 1/00

(52) U.S. Cl. 455/556.2

(57) ABSTRACT

The invention relates to a communications device comprising a touch-sensitive display unit for displaying characters. Said device also comprises a data entry pen for highlighting displayed characters, actuating element and a processor device, which are configured in such a way that the character that is currently highlighted by means of the data entry pen is selected by operating the actuating element.

### CROSS REFERENCE TO RELATED APPLICATIONS

This application claims priority to the German application No. 10348873.1, filed Oct. 21, 2003, and to the International Application No. PCT/EP2004/052597, filed Oct. 20, 2004 which are incorporated by reference herein in their entirety.

### FIELD OF INVENTION

The invention relates to a communications device, in particular a mobile phone, a portable computer or a portable audio/video playback device, which can be adjusted in accordance with the settings of a device profile.

### BACKGROUND OF INVENTION

The continuously advancing development in the field of mobile phones leads to constant miniaturization thereof on the one hand and to continuously improved graphics capabilities therein on the other hand. This results in demands by the users of such mobile phones for efficient use of these graphics capabilities in the mobile phones despite the limited area of the display unit available.

To input graphics objects into a communications device it is known to connect the communications device to a data entry pen, which has a sensor arrangement in its tip. The movement of the tip of the data entry pen, and thus the movement of the data en try pen relative to the surface over which the movement of the data entry pen takes place, is detected by this sensor arrangement. The detected relative movement can subsequently be converted into a graphics object that corresponds to the relative movement, which object is ultimately displayed on the display unit. By way of example, the letter “a” can thus be written as a graphics object with the data entry pen in order to display this letter “a” as a graphics object on the display unit.

It is also known to configure a touch-sensitive display in such a way that the position of the tip of a data entry pen, which touches the display, can be detected and as a result characters or symbols can be input or selected.

### SUMMARY OF INVENTION

An object of the invention is to also disclose a technical teaching which allows characters displayed on a display unit to be conveniently, reliably and intuitively selected via a data entry pen.

This object is achieved by the features of the independent claims. Advantageous and expedient developments can be found in the dependent claims.

As a result of the invention characters can be conveniently input into communications terminal equipment.

It has been established in usability labs especially set up for this purpose that the results of the observed users advanced astoundingly rapidly and also produced a very noticeable effect of making the writing process more sedate.

In this case characters are also taken to mean for example a number, a letter, a partial graphics object, such as a circle, a rectangle or an arrow, and/or a plurality of partial graphics objects.

A data entry pen formed independently of the display unit is preferably used as the data entry pen and comprises, in the pen tip for example, a sensor arrangement in order to detect a movement of the data entry pen relative to the display unit or a surface formed independently thereof, such as a table surface, a briefcase surface or a textile surface.

The display unit can in particular be formed by a graphics display or a portion of a graphics display, such as a graphics window.

Alternatively or in addition thereto the data entry pen can be simply configured, i.e. without sensors, and instead the display unit can be touch-sensitive to detect the position of the data entry pen.

Developments of the invention are preferably based on one or more of the following elements:

Keeping the text free before lowering the pen:

If the pen is raised, the keyboard cannot be seen but instead the previously written text can be seen over the entire screen.

Provision of the keyboard when the pen is lowered:

If the pen is lowered a QWERTY keyboard appears on the screen and the current cursor position is displayed. In this case it is possible for the user to pass over both the keyboard and the text.

Typing the selected letters:

If a specifically predefined key is pressed with the left hand or thumb or finger thereof, the previously selected keyboard character is selected and when the finger releases the key the character is written into the text. The position can still be subsequently corrected as the finger presses down.

Renewed positioning of the pen:

Similar to as described above, the procedure of positioning and typing is repeated until the text is written.

The invention is described in more detail below with reference to preferred exemplary embodiments, for the explanation of which the figures listed below are used:

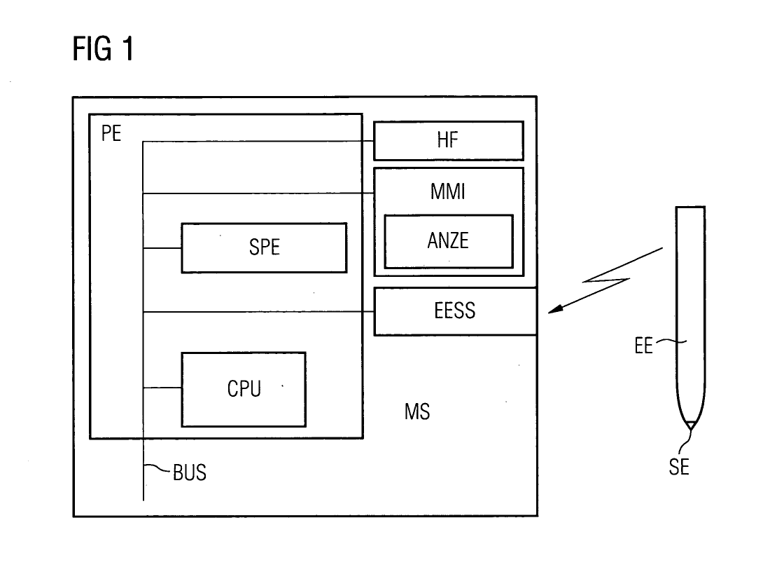

FIG. 1 shows a block diagram of a mobile phone including data entry pen;

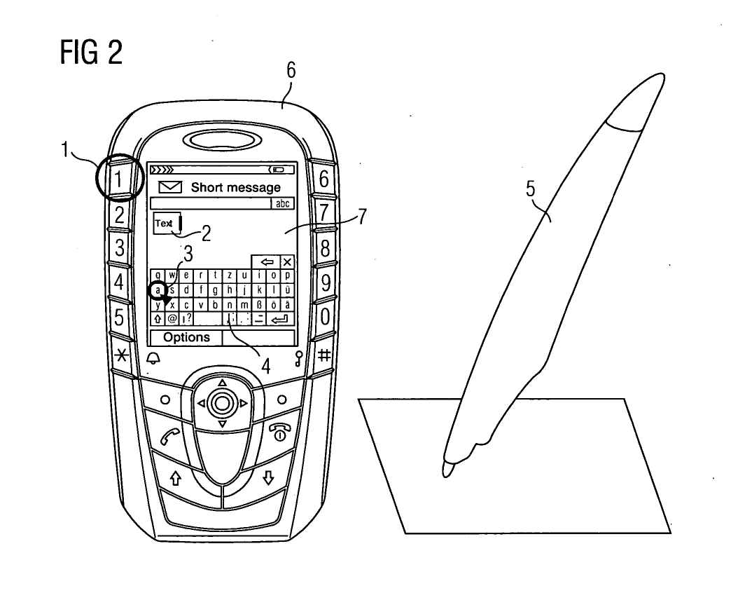

FIG. 2 to 6 show mobile phones according to embodiments of the invention (in this case use by a right-handed person is taken as a basis).

FIG. 1 shows a mobile phone MS which contains an operating device MMI, a high frequency device HF and a processor PE. The operating device MMI comprises a display unit ANZE, such as a graphics display, and actuating elements, such as keys or softkeys.

For controlling the mobile phone MS, and the methods which are executed by the mobile phone, a program-controlled processor PE, such as a microcontroller, is provided which can also comprise a processor CPU and a storage device SPE.

Depending on the embodiment further components, associated with the processor, forming part of the processor, controlled by the processor or controlling the processor, such as a digital signal processor, or further storage devices, can be arranged inside or outside the processor PE, of which components the principle function, in conjunction with a processor, for controlling a mobile phone is sufficiently known to a person skilled in the art and will therefore not be discussed in detail at this juncture. The different components can exchange data with the processor CPU via a bus system BUS or input/output interfaces and if necessary suitable controllers.

The program data, such as the control commands or control procedures, which are used to control the mobile phone, are stored in the storage device SPE.

By way of an input device interface EESS the mobile phone MS is cordlessly connected or connected via a cord to an input device, in particular a data entry pen EE, which contains a sensor arrangement SE for detecting the movement of the input device relative to a surface.

As an alternative to the embodiment just described, a further embodiment makes provision for a simple data entry pen without sensors and combined with a touch—sensitive display unit.

FIG. 2 shows a mobile phone 6 with a data entry pen 5. A text 2 “Text” and virtual QWERTZ keyboard 4 is displayed on the display unit 7. At the edge of the mobile phone 6 there is provided as an actuating element a key 1 which can also be used for inputting a telephone number. A character “a” currently highlighted by the pen is displayed so as to be emphasized by a cursor 3. On actuation of the key 1 this character “a” that is instantaneously highlighted by the data entry pen is selected and input as a component of a text into the mobile phone.

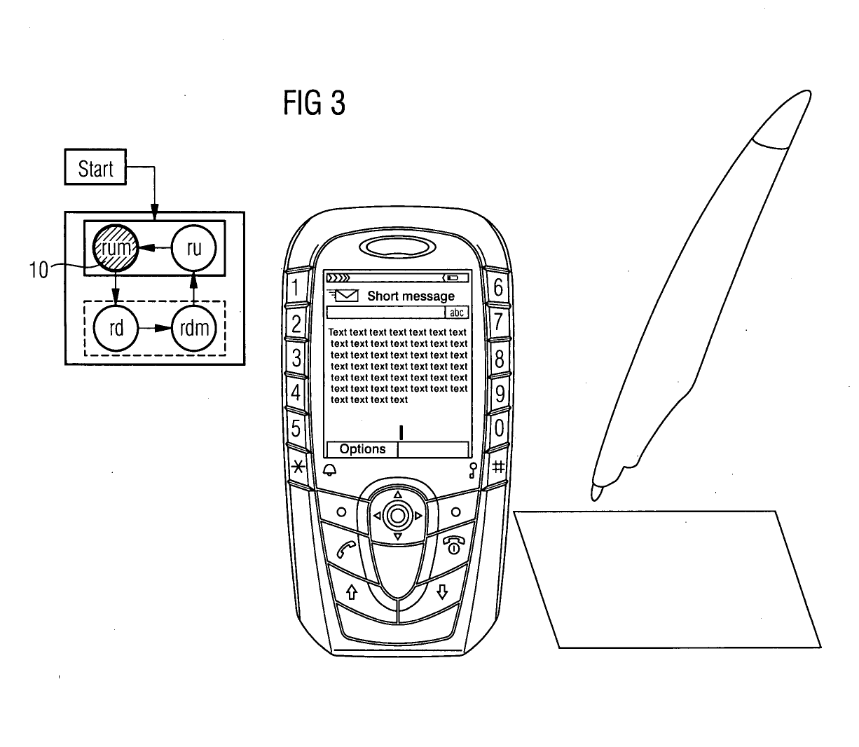

The following abbreviations are used in the following flow diagrams of FIG. 3 to 6:

Start: start of the algorithm

S: jump to start

rd: right-down (data entry pen (pen) is lowered)

rdm: right-move-down (pen is lowered onto the pad)

ru: right-up (pen is raised)

rum: right-up-move (pen is moved while raised above the pad); the system “sees” this movement

rumb: right-up-move-blind (pen is moved outside the detection range of the system. This will not be examined here)

ld: left-down (the left-hand key—in the example this would be the “1” on SX1—is pressed)

lu:left-up (the left-hand key is released/not pressed)

The black arrows are transitions from one event to the next, with the black arrow being relevant in the execution which shows the next associated event.

The gray speech bubbles indicate potential actions.

FIG. 3 shows the mobile phone in the “rum” state and waiting for a user input (action 10).

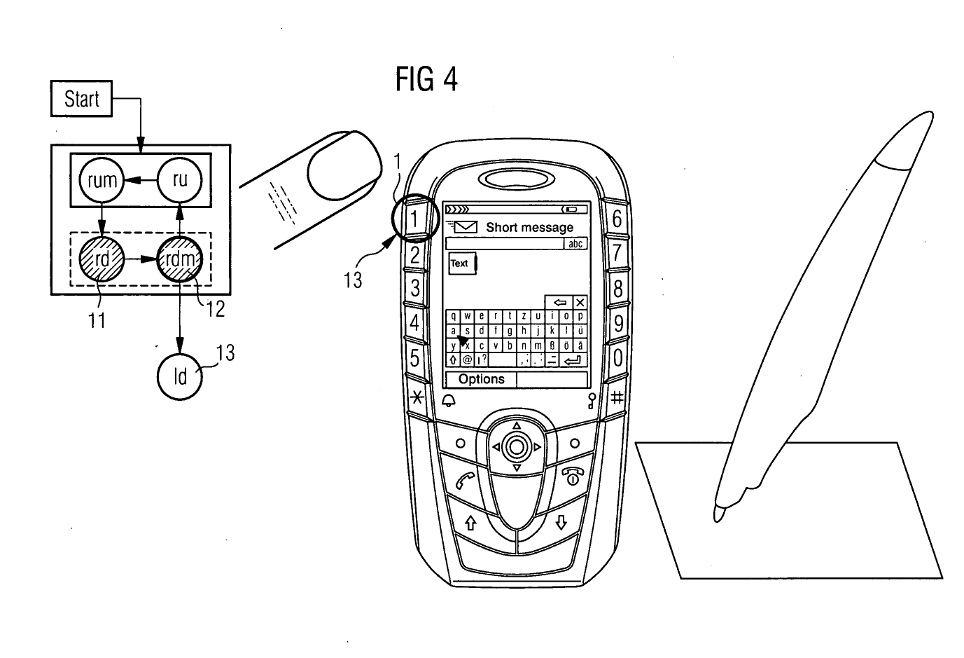

In FIG. 4 action 11 starts the keyboard input and displays the virtual keyboard for this purpose. In action 12 a virtual marker is positioned and a text operation carried out. In action 13 the character instantaneously highlighted on the virtual keyboard is selected with actuation of the key 1 and is displayed as text in the text field.

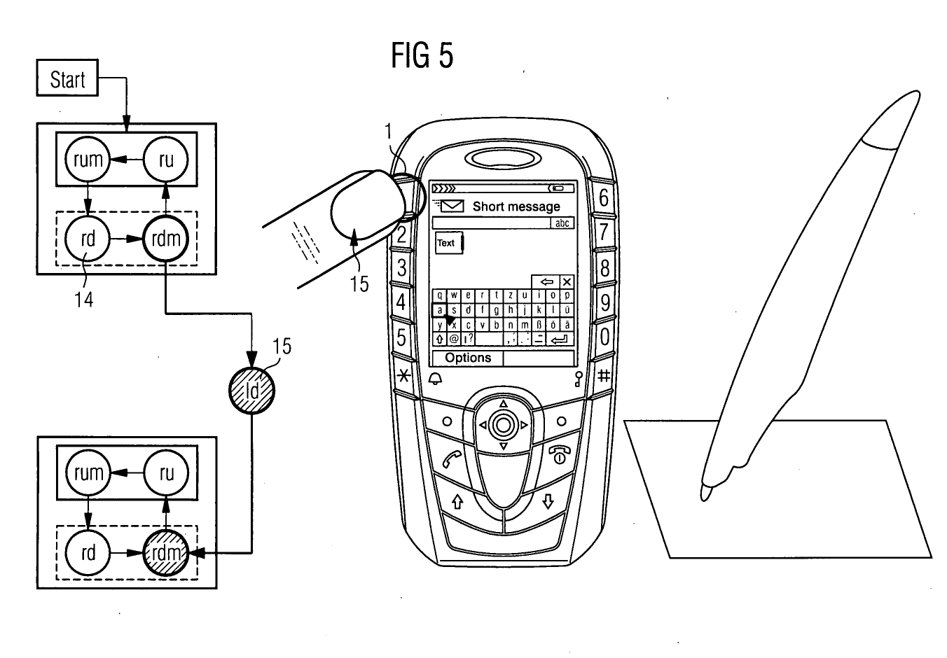

In FIG. 5 the keyboard input is started in action 14 and the virtual keyboard is displayed for this purpose. In action 15 key 1 is actuated and the letter “a” currently selected by the pen is displayed so as to be emphasized. As long as key 1 is pressed the choice of character can still be corrected in this exemplary embodiment by the data entry pen (action 16).

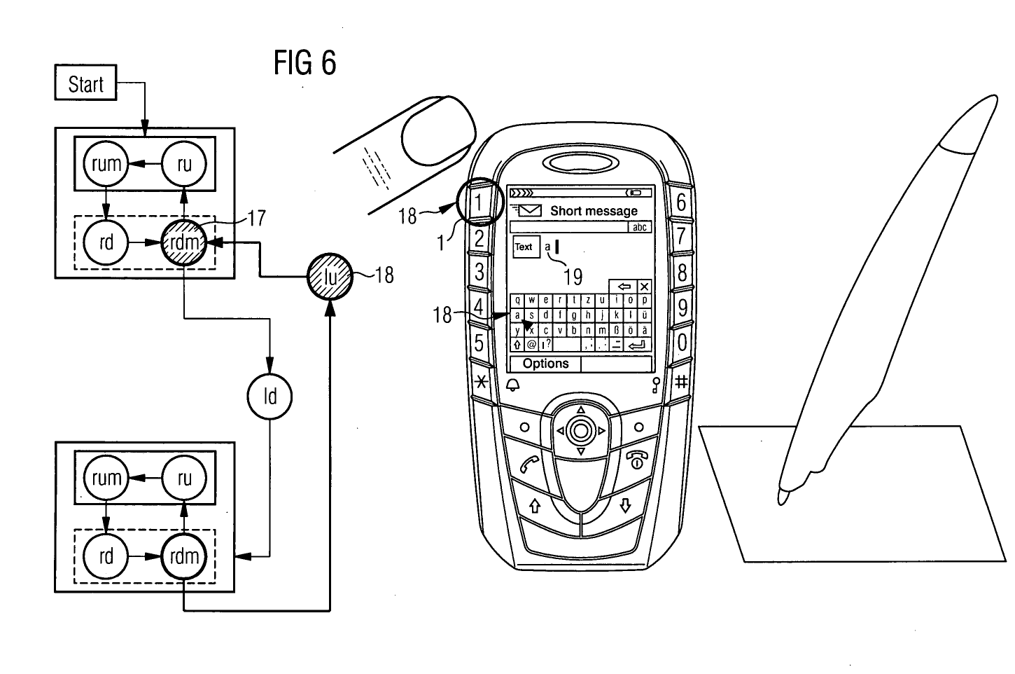

In FIG. 6 the next positioning of the data entry pen is started in action 17. In action 18 key 1 is released and the previously highlighted letter “a” is selected and appears in the text field (action 19).

One embodiment of the invention provides that, as a data entry pen, a Bluetooth pen is connected to a mobile phone such that a right-handed person holds the pen in his right hand and, as required, can, after brief familiarization, write flowing text by simultaneously pressing the left-hand key “1” with his left thumb.

One embodiment of the invention provides that, as a data entry pen, a Bluetooth pen is connected to a mobile phone such that a left-handed person holds the pen in his left hand and, as required, can, after brief familiarization, write flowing text by simultaneously pressing the right-hand key “6” with his right thumb.

In addition to the above-described embodiments of the invention there are also a large number of further embodiments within the framework of the invention, which are not described here but can easily be implemented in practice with reference to the embodiments described.

1.-8. (canceled)

9. A communications device, comprising:
a display unit for displaying characters;
a data entry pen for highlighting displayed characters;
an actuating element; and
a processor functionally connected to the actuating element for selecting such character currently highlighted by the data entry pen upon actuating the actuating element by a user.

10. The communications device according to claim 9, wherein the display unit is a touch-sensitive display unit.

11. The communications device according to claim 9, wherein the actuating element and the data entry pen are physically or functionally separate elements.

12. The communications device according to claim 9, wherein the actuating element is configured to be actuated by either pressing the actuating element or releasing the actuating element.

13. The communications device according to claim 9, further comprising a virtual keyboard configured to be automatically displayed on the display unit upon the data entry pen entering an approach zone arranged in front of the display unit.

14. The communications device according to claim 9, further comprising a virtual keyboard configured to be automatically displayed on the display unit upon the data entry pen touching the display unit.

15. The communications device according to claim 13, wherein the virtual keyboard is automatically removed from the display unit when the data entry pen leaves the approach zone.

16. The communications device according to claim 14, wherein the virtual keyboard is automatically removed from the display unit when the data entry pen loses touch with the display unit.

17. The communications device according to claim 9, wherein the actuating element includes a key of the communications device, the key also serving other functional purposes of the communications device.

18. The communications device according to claim 13, wherein characters of the virtual keyboard are configured to be highlighted by the data entry pen,
highlighted characters of the virtual keyboard are configured to be selected by actuating the actuating element, and
a selected highlighted character of the virtual keyboard is displayed in a text field of the display unit.

19. The communications device according to claim 14, wherein characters of the virtual keyboard are configured to be highlighted by the data entry pen,
highlighted characters of the virtual keyboard are configured to be selected by actuating the actuating element, and
a selected highlighted character of the virtual keyboard is displayed in a text field of the display unit.

20. The communications device according to claim 9, wherein a selected highlighted character is displayed in an accentuated form for easy visual distinction of the selected highlighted character from other displayed characters.
